(19) United States
(12) Patent Application Publication
(10) Pub. No.: US 2026/0077602 A1
(43) Pub. Date: Mar. 19, 2026

(54) PRINTING APPARATUS, CONTROL METHOD, AND STORAGE MEDIUM

(71) Applicant: CANON KABUSHIKI KAISHA, Tokyo (JP)

(72) Inventors: TAICHI YOKOKAWA, Kanagawa (JP); TAKESHI YAZAWA, Kanagawa (JP); HIDEHIKO KANDA, Kanagawa (JP)

(21) Appl. No.: 19/332,825

(22) Filed: Sep. 18, 2025

(30) Foreign Application Priority Data
Sep. 19, 2024 (JP) 2024-162435

(51) Int. Cl. B41J 2/21; B41J 25/00; B41M 3/00

(52) U.S. Cl. CPC B41J 2/2121; B41J 2/2114; B41J 25/005; B41M 3/001

(57) ABSTRACT

A printing apparatus includes: a printing unit having a first ejection port array and a second ejection port array; and a control unit configured to execute multipass printing to print an image in a predetermined region on a printing medium by scanning the printing unit N times (N is an integer equal to or greater than 2) in a main scanning direction intersecting a sub-scanning direction, and to perform control so that, in a case where an application amount of a color material ink per unit area corresponding to the predetermined region on the printing medium is a first amount, a first ratio of an application amount of the color material ink for printing in last N/2 scans to an application amount of the color material ink for printing in first N/2 scans among the N scans for printing an image is greater than 1.

### BACKGROUND

### Field of the Technology

The present disclosure relates to an inkjet printing apparatus and an inkjet printing method, and more particularly to a technique for an inkjet printing apparatus configured to form images by a multipass printing method using a reaction liquid ink.

### Description of the Related Art

There has been known an inkjet printing apparatus configured to print images on a printing medium by ejecting ink from a print head onto the printing medium. In a case where this printing apparatus is used to form an image on a low-permeability printing medium, the ink does not easily permeate into the printing medium and remains on the printing medium. At this time, adjacent different color material ink droplets contact each other, causing bleeding between the color material ink droplets. In order to reduce this bleeding, there is also known a method using a reaction liquid ink (also simply referred to as a reaction liquid) that reacts with a color material contained in the color material ink. By making the color material ink and the reaction liquid ink contact each other on the printing medium, aggregation of the color material contained in the color material ink is caused to reduce the bleeding. However, if the reaction liquid ink is applied more than necessary, excessive aggregation occurs with the color material, resulting in a problem a decrease in gloss of the resulting printed material. To address this problem, Japanese Patent Laid-Open No. 2002-321349 describes that the amount of reaction liquid ink applied is appropriately changed according to the amount of color material ink applied.

As for a so-called multipass printing method in which all pixels in a printable area in one scan are divided into a plurality of groups and printing of the area is completed in a plurality of scans, there is also a printing apparatus configured to control the application order of the color material ink and the reaction liquid ink. This control is performed to complete the application of the reaction liquid ink in fewer scans than the plurality of scans to apply the color material ink, thereby increasing the probability of contact with the reaction liquid ink before bleeding occurs between the color material ink droplets.

### SUMMARY

However, merely changing the amount of the reaction liquid according to the amount of the color material ink used may cause the minimum amount of the reaction liquid required to suppress bleeding and beading of the color material ink to exceed the upper limit of the reaction liquid required to ensure gloss and robustness.

In view of the above problems, the present disclosure aims to reduce deterioration in gloss and robustness while suppressing bleeding and beading of the color material ink.

One embodiment of the present disclosure is a printing apparatus including: a printing unit having a first ejection port array in which ejection ports for ejecting a color material ink are arrayed along a sub-scanning direction, and a second ejection port array in which ejection ports for ejecting a reaction liquid are arrayed along the sub-scanning direction; and a control unit configured to execute multipass printing to print an image in a predetermined region on a printing medium by scanning the printing unit N times (N is an integer equal to or greater than 2) in a main scanning direction intersecting the sub-scanning direction, and to perform control so that, in a case where an application amount of the color material ink per unit area corresponding to the predetermined region on the printing medium is a first amount, a first ratio of an application amount of the color material ink for printing in last N/2 scans to an application amount of the color material ink for printing in first N/2 scans among the N scans for printing an image is greater than 1, and, in a case where the application amount of the color material ink per unit area corresponding to the predetermined region on the printing medium is a second amount larger than the first amount, a second ratio of the application amount of the color material ink for printing in the last N/2 scans to the application amount of the color material ink for printing in the first N/2 scans among the N scans for printing an image is equal to or greater than 1 and smaller than the first ratio.

Features of the present disclosure will become apparent from the following description of embodiments with reference to the attached drawings. The following description of embodiments is described by way of example.

### BRIEF DESCRIPTION OF THE DRAWINGS

FIG. 1 is a perspective view illustrating an external appearance of a printing apparatus in a first embodiment.

FIG. 2 is a side view of a printing apparatus main body in the first embodiment.

FIG. 3 is a diagram of a print head in the first embodiment.

FIG. 4 is a block diagram of a printing system in the first embodiment.

FIG. 5 is a block diagram for explaining a flow of image data conversion processing in the first embodiment.

FIG. 6 is a diagram schematically illustrating how multipass printing is performed in the first embodiment.

FIG. 7 is a flowchart illustrating a flow of mask selection processing in the first embodiment.

FIG. 8 is a diagram illustrating mask selection data in the first embodiment.

FIGS. 9A and 9B are diagrams for explaining a mask for color material ink in the first embodiment.

FIGS. 10A to 10C are diagrams for explaining the masks selected for each amount of color material ink applied in the first embodiment.

FIG. 11 is a diagram for explaining a mask for a reaction liquid in a second embodiment.

FIGS. 12A and 12B are diagrams for explaining masks selected for each amount of reaction liquid applied in the second embodiment.

FIGS. 13A and 13B are diagrams illustrating mask allocation and ink application amount in a third embodiment.

### DESCRIPTION OF THE EMBODIMENTS

Preferred embodiments of the present disclosure will be described in detail below by way of example with reference to the drawings. However, components described in the following embodiments are merely examples, and are not intended to limit the scope of the present disclosure to only those components.

### First Embodiment

### <Configuration of Inkjet Printing Apparatus>

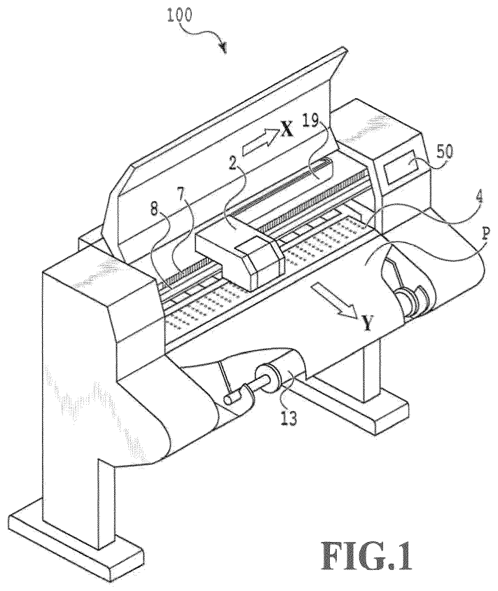

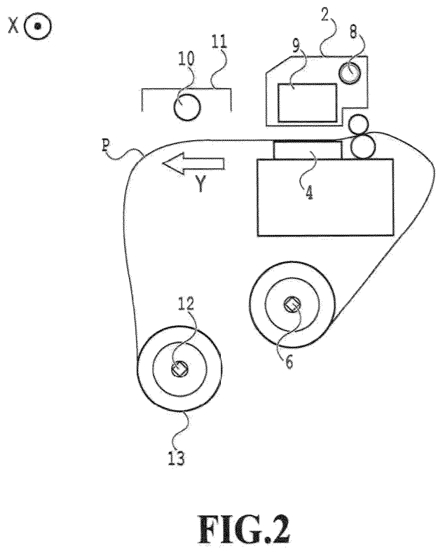

A configuration of a printing apparatus 100 and an outline of operations during printing will be described below with reference to FIGS. 1 and 2. FIG. 1 is a view illustrating an external appearance of an inkjet printing apparatus (hereinafter also referred to as a printing apparatus or printer) in the present embodiment. The printing apparatus 100 in FIG. 1 is a so-called serial scanning type printer, in which a print head scans in a scanning direction orthogonal to a conveyance direction of a printing medium P to print an image. FIG. 2 is a view illustrating the configuration of the printing apparatus 100 main body as seen from the side. Note that the scanning direction of the print head will be referred to as an X direction or main scanning direction, and the conveyance direction of the printing medium P will be referred to as a Y direction or sub scanning direction. In describing directions in the present disclosure, in the case of distinguishing whether the direction is positive or negative, the positive symbol + or the negative symbol − is added. In the case where there is no need to distinguish between positive and negative directions, the direction is simply described as the X direction or Y direction. The directions indicated by the arrows in the drawings are the positive directions.

First, the printing medium P is conveyed in the Y direction from a spool 6 holding the printing medium P by a conveyance roller driven via a gear by a conveyance motor (not illustrated). On the other hand, in a predetermined conveyance position, a carriage unit 2 is moved in the +X direction or −X direction by a carriage motor (not illustrated) along a guide shaft 8 extending in the X direction. During this scanning process, an ejection operation is performed from ejection ports of a print head 9 (described later) that can be mounted on the carriage unit 2 at a timing based on a position signal obtained by an encoder 7, and a certain band width corresponding to an array range of the ejection ports is printed. In the present embodiment, a configuration is adopted in which the scanning is performed at a scanning speed of 30 inches per second, and the ejection operation is performed at a printing resolution of 1200 dpi ( 1/1200-inch intervals). After printing of the above-described certain band width, the printing medium P is conveyed, and printing of the next band width is further performed. The ejection ports are also called nozzles.

It should be noted that a carriage belt can be used for transmission of driving force from the carriage motor to the carriage unit 2. However, instead of the carriage belt, another driving system can also be used such as a component including a lead screw that is rotated and driven, for example, by the carriage motor and extends in the X direction and an engaging part that is provided to the carriage unit 2 and engaged with a groove of the lead screw.

The fed printing medium P is nipped and conveyed by a feeding roller and a pinching roller to be guided to a printing position (scanning area of the print head) on a platen 4. In general, since the face surface of the print head 9 is capped in a resting state, the cap is opened before printing to set the print head 9 to a scannable state. Thereafter, as data for one scan is accumulated in a buffer, the carriage motor causes the carriage unit 2 to scan, and the printing is performed as described above.

A flexible wiring board 19 is attached to the print head 9 to supply a driving pulse for driving ejection elements, a head temperature adjustment signal, and the like. The other end of the flexible wiring board 19 is connected to a control unit (not illustrated) including a control circuit such as a CPU that controls the printer. A display panel 50 is configured so that a user can input or confirm suspension of a print operation, information on the printing medium P, and the like. A graphical user interface screen (referred to as a GUI screen) is displayed on the display panel 50.

A heater 10 supported by a frame (not illustrated) is disposed in a curing area located on the downstream side, in the Y direction, of a position where the print head 9 mounted on the carriage unit 2 scans reciprocally in the X direction. The heater 10 dries ink in liquid form on the printing medium P by heat. The heater 10 is covered by a heater cover 11. The heater cover 11 has a function of efficiently irradiating heat from the heater 10 onto the printing medium P and a function of protecting the heater 10. After printing is performed by the print head 9, the printing medium P is wound up by a take-up spool 12 to form a roll-shaped winding medium 13. Specifically, the heater 10 may be a sheathed heater, a halogen heater or the like. The heating temperature of the heating unit in the curing area is set in consideration of the film-forming properties and productivity of water-soluble resin particles, and the heat resistance of the printing medium P. The heating means of the heating unit in the curing area can be heating by blowing hot air from above, or heating by a contact-type heat conduction heater from below the printing medium. Although the present embodiment illustrates an example where the heating means of the heating unit in the curing area is provided in one location, the heating means may be provided in two or more locations and used in combination, as long as the temperature measured by a radiation thermometer (not illustrated) does not exceed the set value of the heating temperature on the printing medium P.

The printing apparatus 100 of the present embodiment can perform so-called multipass-type printing (also simply called multipass printing), in which the print head scans a plurality of times (n times) to print an image in a predetermined area (1/n band) on the printing medium P. The multipass printing will be described in detail later.

### <Configuration of Print Head>

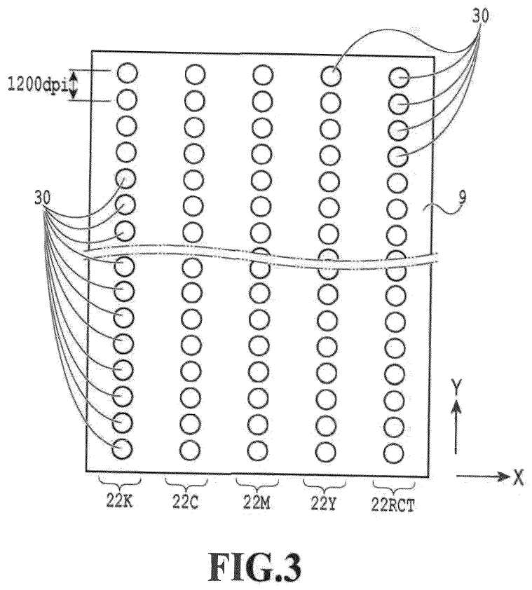

FIG. 3 is a diagram illustrating the print head 9 of the present embodiment. The print head 9 includes ejection port arrays 22K, 22C, 22M, and 22Y for ejecting black ink (K), cyan ink (C), magenta ink (M), and yellow ink (Y), respectively, as inks containing color materials. Since these black ink (K), cyan ink (C), magenta ink (M), and yellow ink (Y) each contain a color material, these inks will also be referred to as color material inks for simplicity in the following description.

The print head 9 also includes an ejection port array 22RCT for ejecting a reaction liquid ink (RCT) containing no color material. This reaction liquid ink (hereinafter also referred to as reaction liquid) does not contain a color material, but contains a reactive component that reacts with the color material contained in the color material ink. The reaction liquid ink can reduce bleeding by coming into contact with the color material ink on the printing medium. The ejection port arrays 22K, 22C, 22M, and 22Y for ejecting the color material inks are provided on the upstream side of the ejection port array 22RCT in the main scanning direction (+X direction).

Each ejection port array has ejection ports arrayed along the sub-scanning direction. In the print head 9, these ejection port arrays are arranged in the order of the ejection port arrays 22K, 22C, 22M, 22Y, and 22RCT from left to right in FIG. 3 in the main scanning direction (X direction) that intersects with the sub-scanning direction. These ejection port arrays 22K, 22C, 22M, 22Y, and 22RCT are configured to have 1280 ejection ports 30 arrayed in the Y direction (array direction, sub-scanning direction) at a density of 1200 dpi for eject the respective inks. In the present embodiment, the amount of ink ejected from one ejection port 30 at one time is about 4.5 pl.

These ejection port arrays 22K, 22C, 22M, 22Y, and 22RCT are connected to ink tanks (not illustrated) that store the corresponding inks, and the inks are supplied thereto. In the present embodiment, the print head 9 and the ink tanks may be configured integrally or separately.

A detailed composition of each of the black ink (K), cyan ink (C), magenta ink (M), yellow ink (Y), and reaction liquid (RCT) will be described later. Incidentally, water-soluble resin particles that form a film upon heating and improve the scratch resistance of the printed material may be included in each color material ink, or may be included in a clear emulsion ink (Em), which is a third ink that is different from the color material ink or the reaction liquid and contains no color material. In this case, the print head 9 may include an ejection port array 22Em for ejecting the clear emulsion ink.

### <Configuration of Printing System>

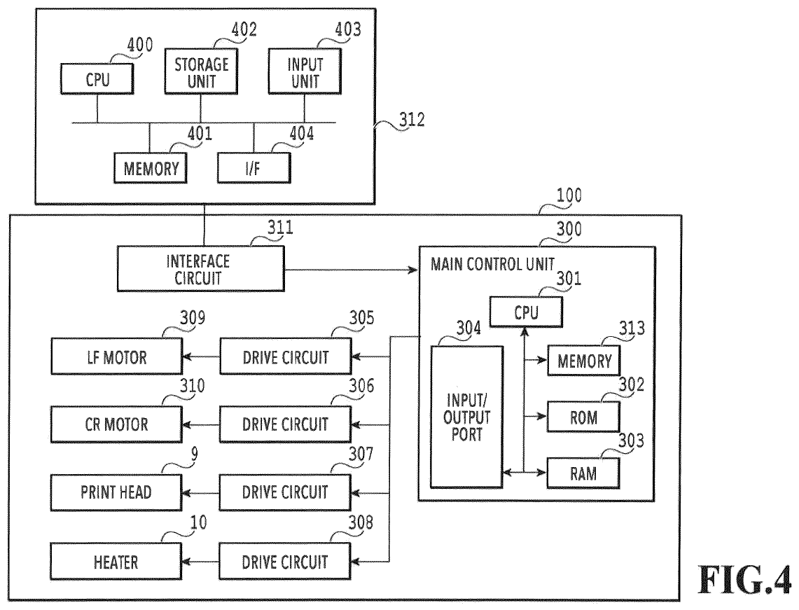

FIG. 4 is a block diagram illustrating a schematic configuration of a printing system including a host apparatus 312 and a control system in the printing apparatus 100 in the present embodiment. The host apparatus 312 is an information processing apparatus, such as a personal computer or a digital camera, connected to the printing apparatus 100. The host apparatus 312 includes a CPU 400, a memory 401, a storage unit 402, an input unit 403 such as a keyboard or a mouse, and an interface 404 for communication with the printing apparatus 100. The CPU 400 executes various processes according to programs stored in the memory 401. These programs are generally supplied from an external device such as a CD-ROM for storage in the storage unit 402, but may be prestored in the storage unit 402.

The host apparatus 312 is connected to the printing apparatus 100 via the interface 404, and transmits image processing information to the printing apparatus 100, including image data represented by R, G, and Bin an image processing step to be described later, and a table (print control information) for subsequent image processing. Based on the transmitted image processing information, the printing apparatus 100 executes image processing such as color processing and binarization to be described later, and correction processing of printing characteristics. The host apparatus 312 may execute at least part of the color processing, image processing, and correction processing.

The printing apparatus 100 has a main control unit 300.The main control unit 300 includes a CPU 301 configured to perform processing operations such as calculation, selection, determination, and control, as well as printing operations. The main control unit 300 also includes a ROM 302 for storing control programs to be executed by the CPU 301, a RAM 303 used as a buffer or the like for printing data, and an input/output port 304. The memory 313 stores data such as masks to be described later. The input/output port 304 is connected to a conveyance motor (LF motor) 309, a carriage motor (CR motor) 310, the print head 9, and drive circuits 305, 306, 307, and 308 for actuators in the heater 10. The main control unit 300 is connected to the host apparatus 312 via an interface circuit 311.

### <Printing Medium>

The printing apparatus in the present embodiment prints an image on a low-permeability printing medium, into which liquid does not easily permeate. The low-permeability printing medium referred to here is a medium that absorbs no or very little water. Therefore, with aqueous ink containing no organic solvent, the ink is repelled and images cannot be formed. On the other hand, the low-permeability printing medium has excellent water resistance and weather resistance, and is suitable as a medium for forming a printed material for outdoor use. A printing medium with a water contact angle of 45° or more, preferably 60° or more at 25° C. is used as the low-permeability printing medium.

The low-permeability printing media include a printing medium with a plastic layer formed on the outermost surface of a substrate, or a printing medium with no ink receiving layer formed on the substrate. Alternatively, the low-permeability printing medium may be a sheet of glass, synthetic paper, or plastic, or a film or banner. Examples of the plastic include polyvinyl chloride, polyethylene terephthalate, polycarbonate, polystyrene, polyurethane, polyethylene, and polypropylene. These low-permeability printing media have excellent water resistance, light resistance, and abrasion resistance, and are therefore generally used in a case of printing materials for outdoor exhibition.

### <Composition of Ink and Reaction Liquid>

The inks constituting an ink set used in the present embodiment will be described in detail below. Note that “parts” and “%” are based on mass unless otherwise specified.

### 1. Composition of Each Ink

The composition of each ink will be described in detail below. The color material inks (C, M, Y, K) and the reaction liquid (RCT) used in the present embodiment all contain water-soluble organic solvents. For reasons of wettability and moisture-retaining property of the face surface of the print head 9, the water-soluble organic solvent is preferably one with a boiling point of 150° C. to 300° C. In addition, from the viewpoint of the function of a film-forming assistant for resin fine particles and swelling solubility to a printing medium having a resin layer formed therein, the following are particularly preferable. Specifically, ketone compounds such as acetone and cyclohexanone, propylene glycol derivatives such as tetraethylene glycol dimethyl ether, heterocyclic compounds having a lactam structure such as N-methyl-pyrrolidone and 2-pyrrolidone are particularly preferable. From the viewpoint of ejection performance, the content of the water-soluble organic solvent is preferably 3 wt % to 30 wt %. The water soluble organic solvent can be used alone or as a mixture. Also, deionized water is preferably used as the water. The content of the water-soluble organic solvent in the reaction liquid (RCT) is not particularly limited, but the color material inks (C, M, Y, K) can be appropriately added with surfactants, defoamers, preservatives, antifungal agents or the like in addition to the above-mentioned components, in order to have desired physical properties as necessary.

The surfactants are used as penetrants for the purpose of improving the permeability of the ink to the printing medium dedicated to inkjet printing. The larger the amount of the surfactant added, the stronger the property of lowering the surface tension of the ink, and the better the wettability and permeability of the ink to the printing medium.

The pH of each ink in the present embodiment is stable on the alkaline side, with a value of 8.5 to 9.5. From the viewpoint of suppressing the elution and deterioration of members in contact with each ink in the printing apparatus or print head, and a decrease in solubility of dispersed resin in the ink, the pH of each ink is preferably 7.0 to 10.0. In addition, a white ink (W) may be further provided as the color material ink.

### 2. Reaction Liquid Ink

In the present embodiment, a reaction liquid is used to insolubilize part or all of solid components of the color material ink, in order to solve image problems such as bleeding.

In order to insolubilize dissolved dyes and dispersed pigments and resins, the reaction liquid may be, for example, a solution containing polyvalent metal ions (for example, magnesium nitrate, magnesium chloride, aluminum sulfate, iron chloride, and the like). One type of aggregation action using such cations is the neutralization of charges of water-soluble resin particles and the insolubilization of anionic soluble substances, and a system using a low molecular weight cationic polymer flocculant for these purposes can also be used.

Another reaction system is an insolubilization system using a reaction liquid that utilizes a difference in pH. As mentioned above, most color material inks generally used in inkjet printing are stable on the alkaline side due to the nature of the color materials, and the pH is generally around 7 to 10. From an industrial standpoint and in consideration of the influence of the external environment, the pH is often set to around 8.5 to 9.5 in many cases. In order to aggregate and solidify the color material ink in such a system, an acidic solution is mixed to change the pH and thereby destroy the stable state and aggregate the dispersed components. For this purpose, an acidic solution can be used as the reaction liquid.

### 3. Water-Soluble Resin Particles

The color material ink used in the present embodiment contains water-soluble resin particles. The term “water-soluble resin particles” means polymer particles that exist in a dispersed state in water. Also usable are core-shell type resin particles in which the polymer composition is different between a core part and a shell part, which constitute the resin particles, or resin particles obtained by emulsion polymerization around pre-synthesized acrylic particles used as seed particles to control the particle size, and the like. Furthermore, hybrid resin particles may be used in which different resin particles such as acrylic resin particles and urethane resin particles are chemically bonded.

The water-soluble resin particles do not necessarily have to be contained in the color material ink, but may be contained in a clear emulsion ink (Em), which is a third ink that is different from the color material ink and the reaction liquid and contains no color material.

### <Details of Ink Composition>

### 1. Black Ink

(1) Preparation of Dispersion First, an anionic polymer P-1 [a styrene/butylacrylate/acrylic acid copolymer (polymerization ratio (weight ratio)=30/40/30), having an acid value of 202 and a weight-average molecular weight of 6500] was prepared. This anionic polymer P-1 was neutralized by an aqueous potassium hydroxide solution, and diluted with ion exchanged water, thereby preparing an aqueous homogeneous 10-mass ¾ water-soluble resin particle dispersion.

600 g of the above-described polymer solution, 100 g of carbon black, and 300 g of ion-exchanged water were mixed and mechanically stirred for a predetermined time, and then centrifugally separated to remove a non-dispersion containing coarse particles, thereby obtaining a black dispersion. The obtained black dispersion had a pigment concentration of 10 mass %.

### (2) Ink Preparation

Ink was prepared by adding the following components to the above-described black dispersion at a predetermined concentration. After these components were thoroughly mixed and stirred, the dispersion was filtered under pressure through a microfilter (manufactured by FUJIFILM) having a pore size of 2.5 μm, thereby preparing a pigment ink having a pigment concentration of 2 mass %.
Above-described black dispersion: 20 parts
Above-described water-soluble resin particle dispersion: 40 parts
Zonyl FSO-100 (fluorosurfactant manufactured by DuPont): 0.05 parts
2-methyl 1,3-propanediol: 15 parts2-pyrrolidone: 5 partsAcetylene glycol EO adduct (manufactured by Kawaken Fine Chemicals): 0.5 parts
Ion-exchanged water: balance

### 2. Cyan Ink

### (1) Preparation of Dispersion

First, an AB block polymer having an acid value of 250 and a number-average molecular weight of 3000 was made by an ordinary method using benzyl acrylate and methacrylic acid as raw materials, neutralized with an aqueous potassium hydroxidesolution, and diluted with ion-exchanged water, thereby preparing an aqueous homogeneous SO-mass % resin particle dispersion.

200 g of the above-described polymer solution, 100 g of C.I. pigment blue 15:3, and 700 g of ion-exchanged water were mixed and mechanically stirred for a predetermined time, and then centrifugally separated to remove a non-dispersion containing coarse particles, thereby obtaining a cyan dispersion. The obtained cyan dispersion had a pigment concentration of 10 mass %.

### (2) Ink Preparation

Ink was prepared by adding the following components to the above-described cyan dispersion at a predetermined concentration. After these components were thoroughly mixed and stirred, the dispersion was filtered under pressure through a microfilter (manufactured by FUJIFILM) having a pore size of 2.5 μm, thereby preparing a pigment ink having a pigment concentration of 2 mass %.
Above-described cyan dispersion: 20 parts
Above-described water-soluble resin particle dispersion: 40 parts
Zonyl FSO-100 (fluorosurfactant manufactured by DuPont): 0.05 parts
2-methyl 1,3 propanediol: 15 parts2-pyrrolidone: 5 parts
Acetylene glycol EO adduct (manufactured by Kawaken Fine Chemicals): 0.5parts
Ion-exchanged water: balance

### 3. Magenta Ink

### (1) Preparation of Dispersion

First, an AB block polymer having an acid value of 300 and a number-average molecular weight of 2500 was made by an ordinary method using benzyl acrylate and methacrylic acid as raw materials, neutralized with an aqueous potassium hydroxide solution, and diluted with ion-exchanged water, thereby preparing an aqueous homogeneous 50-mass ¾ water-soluble resin particle dispersion.

100 g of the above-described polymer solution, 100 g of C.I. pigment red 122, and 800 g of ion-exchanged water were mixed and mechanically stirred for a predetermined time, and then centrifugally separated to remove a non-dispersion containing coarse particles, thereby obtaining a magenta dispersion. The obtained magenta dispersion had a pigment concentration of 10 mass %.

### (2) Ink Preparation

Ink was prepared by adding the following components to the above-described magenta dispersion at a predetermined concentration. After these components were thoroughly mixed and stirred, the dispersion was filtered under pressure through a microfilter (manufactured by FUJIFILM) having a pore size of 2.5 μm, thereby preparing a pigment ink having a pigment concentration of 3 mass %.
Above-described magenta dispersion: 30 parts
Above-described water-soluble resin particle dispersion: 40 parts
Zonyl FSO-100 (fluorosurfactant manufactured by DuPont): 0.05 parts
2-methyl 1,3 propanediol: 15 parts2-pyrrolidone: 5 parts
Acetylene glycol EO adduct (manufactured by Kawaken Fine Chemicals): 0.5 parts
Ion-exchanged water: balance

### 4. Yellow ink

### (1) Preparation of Dispersion

First, the above-described anionic polymer P-1 was neutralized by an aqueous potassium hydroxide solution, and diluted with ion-exchanged water, thereby preparing an aqueous homogeneous 10-mass ¾ resin particle dispersion.

300 g of the above-described polymer solution, 100 g of C.I. pigment yellow 74, and 600 g of ion-exchanged water were mixed and mechanically stirred for a predetermined time, and then centrifugally separated to remove a non-dispersion containing coarse particles, thereby obtaining a yellow dispersion. The obtained yellow dispersion had a pigment concentration of 10 mass %.

### (2) Ink Preparation

The following components were mixed and thoroughly stirred to be dissolved and dispersed. Then, the dispersion was filtered under pressure through a microfilter (manufactured by FUJIFILM) having a pore size of 1.0 μm, thereby preparing a pigment ink having a pigment concentration of 4 mass %.

Above-described yellow dispersion: 40 parts

Above-described water-soluble resin particle dispersion: 40 parts
Zonyl FSO-100 (fluorosurfactant manufactured by DuPont): 0.025 parts
2-methyl 1,3 propanediol: 15 parts2-pyrrolidone: 5 parts
Acetylene glycol EO adduct (manufactured by Kawaken Fine Chemicals): 1 part
Ion-exchanged water: balance

### 5. Reaction Liquid

The reaction liquid to be used in the present embodiment contains a reactive component that reacts with a pigment contained in ink and aggregates or gelates the pigment. Specifically, this reactive component is a component capable of destroying the dispersion stability of ink containing a pigment stably dispersed in an aqueous medium by the action of an ionic group, in a case where the component is mixed with the ink on a printing medium or the like. More specifically, glutaric acid is used in the present embodiment.

Note that glutaric acid does not necessarily have to be used, but various water-soluble organic acids or polyvalent metal salts can be used as reactive components of the reaction liquid. The content of the organic acid or polyvalent metal salt is preferably 0.1 mass % to 90.0 mass %, and more preferably 1.0 mass % to 70.0 mass %, based on the total mass of the composition contained in the reaction liquid.

In the present embodiment, as described above, a reaction liquid was prepared by mixing the following components with glutaric acid (manufactured by FUJIFILM Wako Chemicals).
Glutaric Acid: 2 Parts
2-pyrrolidone: 5 parts
2-methyl 1,3 propanediol: 15 parts
Acetylene glycol EO adduct (manufactured by Kawaken Fine Chemicals): 0.5
Ion-exchanged water: balance

### <Image Data Conversion Processing>

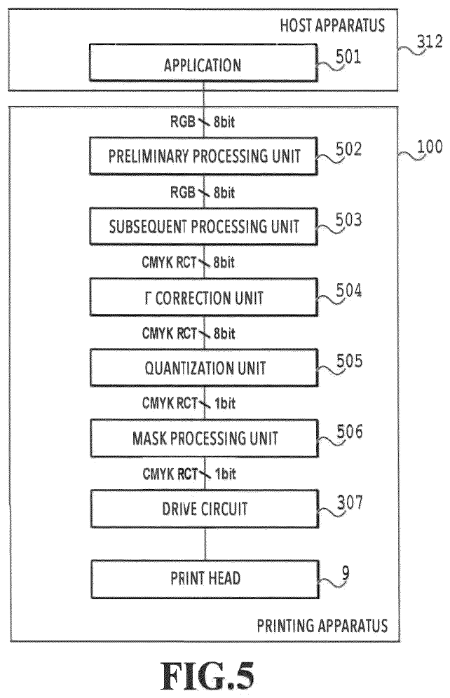

FIG. 5 is a block diagram for explaining a flow of image data conversion processing in the present embodiment. FIG. 5 illustrates the procedure of image processing in which image data inputted to the printing apparatus 100 and represented by 8 bits (256 gradations) per RGB color is converted to 1-bit data for each ink color and outputted. As illustrated in FIG. 5, the printing system is composed of the host apparatus 312 and the printing apparatus 100.

The host apparatus 312 is, for example, a personal computer (PC), and includes an application 501 and a printer driver (not illustrated) for the printing apparatus 100 in the present embodiment. The application 501 executes processing of creating image data to be passed to the printer driver based on information specified by the user via a GUI screen displayed on a display of the host apparatus 312, and processing of setting print control information to control printing.

The image data and print control information processed by the application 501 are passed to the printer driver upon printing. The main control unit 300 of the printing apparatus receives image data transmitted from the host apparatus 312, in which the printer driver is installed, via the interface circuit 311, and performs image processing on the received image data.

The main control unit 300 has a preliminary processing unit 502, a subsequent processing unit 503, a y correction unit 504, a quantization unit 505, and a mask processing unit 506 as a configuration for performing image processing. These units are implemented by the CPU 301 of the main control unit 300 executing a program stored in the ROM 302 or the memory 313. Some or all of the functions of these units may be implemented by hardware such as an ASIC or electronic circuit. Each processing will be briefly described below.

The preliminary processing unit 502 performs gamut mapping. In this processing, data conversion is performed for mapping a gamut reproduced by image data (R, G, B) conforming to the sRGB standard into a gamut reproduced by the printing apparatus 100. Specifically, 256-level data, in which R, G, and B are each expressed in 8 bits, is converted into 8-bit R, G, and B data (RGB values) with different gamuts by using a three-dimensional look-up table (LUT).

The subsequent processing unit 503 converts the R, G, and B data subjected to the gamut mapping by the preliminary processing unit 502 into 8-bit color separation data, which is a combination of inks that reproduces the colors represented by this data, based on the three-dimensional LUT for subsequent processing. In the present embodiment, four colors of inks, C, M, Y, and K, are used as the color material inks. Hence, the subsequent processing unit 503 converts the R, G, and B data into color separation data that is a combination of these ink colors. Here, as with the preliminary processing unit 502, the subsequent processing unit 503 performs the conversion using a three-dimensional LUT in combination with an interpolation operation. Furthermore, the subsequent processing unit 503 also generates 8-bit color separation data of the reaction liquid (RCT) in the ink combination. That is, the subsequent processing unit 503 converts the R, G, and B data into color separation data of C, M, Y, K, and RCT.

The y correction unit 504 converts the density value (gradation value) of each color for the color separation data of each color obtained by the subsequent processing unit 503. Specifically, a one-dimensional LUT is used to perform conversion so that the color separation data is linearly associated with the gradation characteristics of the printing apparatus 100.

The quantization unit 505 performs quantization processing to convert the 8-bit color separation data of each color subjected to the γ correction into 1-bit data. In the present embodiment, a dithering method is used to convert the 8-bit data of 256 gradations into 1-bit data of “1” or “0” (binarization). This makes it possible to obtain binary data indicating whether the printing apparatus ejects ink or not.

The mask processing unit 506 uses a plurality of masks m a complementary relationship with each other to convert the dot arrangement of each color determined by the quantization unit 505 into printing data including timing information for print scan. This mask processing will be described in detail later. Through the mask processing, printing data for each color of C, M, Y, and K is generated for each print scan in multipass printing. The mask processing of the reaction liquid RCT will also be described in detail later.

The generated printing data is supplied to the drive circuit 307 at appropriate timing during a plurality of print scans performed in the multipass printing. The printing data inputted to the drive circuit 307 is converted into a driving pulse for the print head 9, and ink is ejected at a predetermined timing from the ejection ports 30 for each color. In this way, ink is ejected according to the printing data, and an image is printed on the printing medium.

The above example illustrates the configuration in which the printing apparatus 100 executes the processing from the one performed by the preliminary processing unit 502. However, some of the processing may be executed by the printer driver of the host apparatus 312.

### <Multipass Printing>

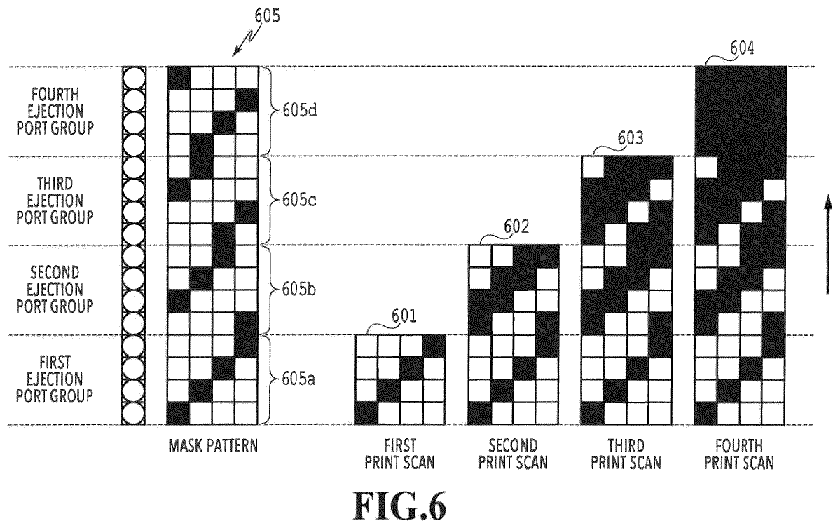

The multipass printing will be described below. The multipass printing is a printing method in which a predetermined print region (unit region) in a predetermined unit area is scanned a plurality of times by the print head to complete an image in the predetermined print region. FIG. 6 is a diagram schematically illustrating how the multipass printing is performed. Although the print head 9 applied to the present embodiment actually has 1280 ejection ports 30, FIG. 6 illustrates the print head 9 having sixteen ejection ports 30, for simplicity, assuming that an image is printed by four print scans.

The ejection ports 30 are divided into four, first to fourth, ejection port groups, and each ejection port group includes four ejection ports. In the multipass printing, printing is performed by scanning a unit region a plurality of times. A mask is used as a means for dividing image data to be printed into a plurality of parts. A mask 605 is composed of masks 605a to 605d. The mask 605a defines a printable area of the first ejection port group. Similarly, the masks 605b to 605d define printable areas of the second to fourth ejection port groups, respectively.

In the mask, black areas indicate printable areas where dot printing is permitted, and white areas indicate non-printable areas where dot printing is not permitted. The masks 605a to 605d as the first to fourth masks are in a complementary relationship with each other. As these four masks are superimposed, printing in a region corresponding to 4×4 areas=16 areas is completed. Printing areas 601 to 604 show how an image is completed by superimposing printing scans.

Every time a print scan is completed, the printing medium is intermittently conveyed in the arrow direction in FIG. 6 by the width of the ejection port group (by the width of four ejection ports in FIG. 6). Therefore, an image is completed by four print scans in the same print area of the printing medium (a predetermined print region corresponding to the width of each ejection port group). The mask processing unit 506 performs AND processing on such a mask and binary image data obtained by the above-mentioned quantization processing, thereby determining binary print data to be printed in each print pass.

In the mask, the ratio of the number of printable areas in each print scan is defined by the print ratio (%). Specifically, with 100% being the region corresponding to the above-described 16 areas, the print ratio in each print scan is expressed as the ratio of the number of printable areas in each print scan. For example, the masks 605a to 605d are masks in which the number of printable areas in each print scan is evenly distributed, and the print ratio of each print scan is all 25%. In a case of using this mask to print an image pattern in which dots are arranged in all of the 16 areas described above, the ink application amount for each print scan is 4 dots.

In the present embodiment, a PET film (GSP-10L) manufactured by Lintec is used as the low-permeability printing medium.

### <Characteristic Configuration of Present Embodiment>

A feature of the present embodiment is that an image is printed with suppressed bleeding and beading by appropriately selecting a mask used in the mask processing of the color material ink performed by the mask processing unit 506. The amount of color material ink applied to a predetermined region is determined based on target image data (R, G, and B data) to be printed in the predetermined region. The mask used in the mask processing of the color material ink performed by the mask processing unit 506 is appropriately selected according to the amount of the color material ink. Then, the selected mask is applied to the color material ink data corresponding to the predetermined region quantized by the quantization unit 505, thereby printing an image with suppressed bleeding and beading. For example, in a case where image data of a first predetermined region is different in content from image data of a second predetermined region (such as a case where the R, G, and B data differ by a predetermined value or more), the masks to be applied are also different from each other. This will be described in detail below.

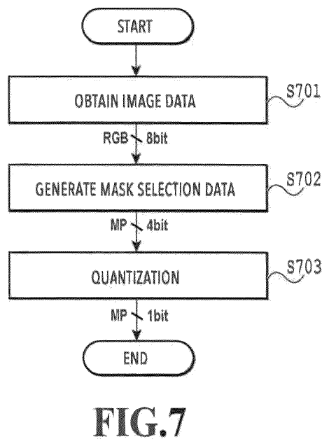

FIG. 7 is a flowchart illustrating a flow of processing for selecting a mask of color material ink according to the amount of color material ink applied (application amount) based on image data of a predetermined region. The processing of FIG. 7 is performed by the main control unit 300. Specifically, the processing of FIG. 7 is implemented by the CPU 301 of the main control unit 300 executing a program stored in the ROM 302 or the memory 313. Some or all of the functions of the steps in FIG. 7 may be implemented by hardware such as an ASIC or electronic circuit. Note that the symbol “S” in the description of each process means a step in the flowchart.

In step S701, the main control unit 300 obtains image data. Here, the main control unit 300 obtains 8-bit R, G, and B data after preliminary processing by the preliminary processing unit 502. Hereinafter, “step S” will be abbreviated as “S”.

In S702, the main control unit 300 converts the R, G, and B data obtained in S701 into 4-bit mask selection data, based on a 3-dimensional LUT for mask selection. Although this mask selection data will be described in detail later, the higher the value of the mask selection data, the larger the amount of color material ink to be applied. The 3-dimensional LUT for mask selection used in this step is a LUT in which, for example, the higher the RGB value, the higher the value of the mask selection data to be converted (generated). Note that this is not necessarily a linear relationship, and the mask selection data is generated by referring to the LUT as appropriate. The mask selection data is generated for each predetermined region to which a mask is applied. In other words, in S702, the image data obtained in S701 is converted into mask selection data for each predetermined region. Note that the above-mentioned 4-bit data is just an example, and the data may be converted to any number of bits. In addition, in a case of generating the mask selection data, the data is not limited to the R, G, and B data after the preliminary processing, but may be converted or generated based on the data after the subsequent processing by the subsequent processing unit 503 or the data after the y correction by the γ correction unit 504.

In S703, the main control unit 300 performs quantization processing to convert each piece of the 4-bit mask selection data into 1-bit data. In the present embodiment, the 4-bit data is converted (binarized) into 1-bit data of “1” or “0” using a dithering method. The mask processing unit 506 performs mask processing of the color material ink using a mask corresponding to the mask selection data of “1” or “0” generated in this step.

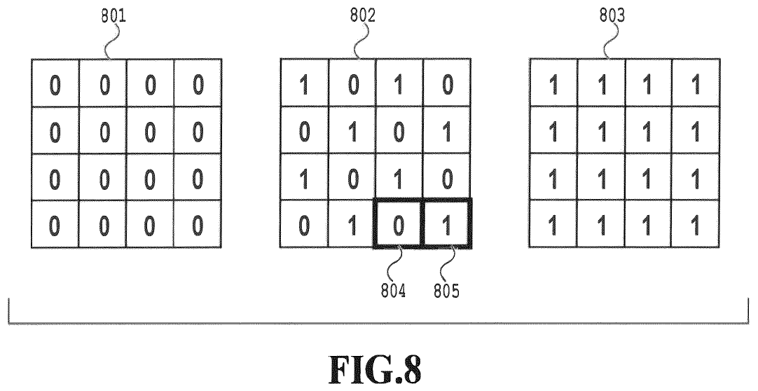

The masks to be applied corresponding to the values of the mask selection data obtained in S703 will be described with reference to FIGS. 8 to 10C. FIG. 8 illustrates three representative examples of mask selection data generated in S703, for each application amount of color material ink, in binary 4×4=16 areas. As mentioned above, the mask selection data differs as appropriate depending on corresponding image data.

FIG. 8 illustrates three examples for explanation purposes. Mask selection data 801 is an example of mask selection data in a case where the application amount of color material ink is relatively small, wherein the mask selection data value is “0” in all 16 areas. Mask selection data 803 is an example of mask selection data in a case where the application amount of color material ink is relatively large, wherein the mask selection data value is “1” in all 16 areas. Mask selection data 802 is an example of mask selection data in a case where the application amount of color material ink is relatively moderate, wherein there are eight areas where the mask selection data value is “0” and eight areas where the mask selection data value is “1”.

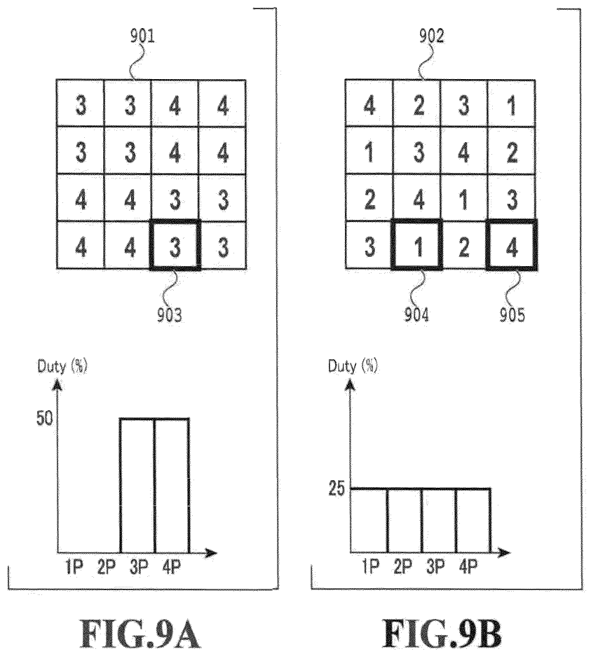

FIGS. 9A and 9B are diagrams illustrating color material ink masks in 4×4=16 areas and the print ratios defined by these masks. FIG. 9A illustrates a post applied mask 901 that is selected in an area where the mask selection data has a value of “0”. In other words, this is a mask selected in an area where the mask selection data value is “0” in the 16 areas. For example, the mask selection data 801 illustrated in FIG. 8 has “0” in all areas, which results in the selection of the same mask as the post-applied mask 901 illustrated in FIG. 9A. On the other hand, FIG. 9B illustrates a normal mask 902 that is selected in an area where the mask selection data has a value of “1” . The post-applied mask 901, which is a first mask, and the normal mask 902, which is a second mask, are masks prestored in the ROM 302 or the like.

In the post-applied mask 901 and the normal mask 902, the numerical value in each area indicates in which scan printing will be performed. For example, “1” in an area 904 illustrated in FIG. 9B indicates the area printed in a first scan. Similarly, “2” indicates the area printed in a second scan, “3” indicates the area printed in a third scan, and “4” indicates the area printed in a fourth scan. In sum, the post-applied mask 901 and the normal mask 902 illustrated in FIGS. 9A and 9B are each composed of four masks (the masks 605a to 605d in FIG. 6) as in the case of the masks illustrated in FIG. 6. In FIGS. 9A and 9B, on the other hand, these four masks are illustrated together as one mask.

As illustrated in FIG. 9B, in the normal mask 902, the number of printable areas in each of first to fourth print scans is four (duty 25%). On the other hand, as illustrated in FIG. 9A, the number of printable areas in the post-applied mask 901 is eight (duty 50%) in the third and fourth print scans, and 0 in the first and second print scans. In other words, the post-applied mask 901 is a mask for completing the application of color material ink in the last two scans. A mask that is printed from the first scan, such as the normal mask 902, is used for the mask of the reaction liquid.

The probability that printing with the color material ink is performed in the later scan than the reaction liquid is relatively higher in a case of using the post-print mask 901 than in a case of using the normal mask 902. Therefore, this post-applied mask 901 is a mask that efficiently suppresses bleeding and beading between the color material inks and does not impair gloss or robustness. However, the print ratio in the third and fourth print scans is higher in the case of using the post-applied mask 901 than in the case of using the normal mask 902. Specifically, as the application amount of color material ink becomes larger than a predetermined amount, bleeding and beading are caused more easily by the color material inks contacting each other before coming into contact with the reaction liquid. Therefore, the post-applied mask 901 is used for the areas where the application amount of color material ink is relatively small (that is, the mask selection data is 0). On the other hand, the normal mask 902 is used for the areas where the application amount of color material ink is relatively large (that is, the mask selection data is 1). Specifically, among the mask selection data defined by the 16 areas, the area of “0” is filled with the value of the position corresponding to that area in the post-applied mask 901. Meanwhile, the area of “1” is filled with the value of the position corresponding to that area in the normal mask 902. In this way, a mask having all areas filled with corresponding values is selected. By selecting a mask to be used in the mask processing as described above, bleeding and beading between the color material inks can be suppressed, and deterioration in gloss and robustness can also be reduced. The mask selected in response to the value in each area of the mask selection data may be applied by selecting a pattern stored in the ROM 302 or the like, or a mask appropriately generated from the post-applied mask 901 and the normal mask 902 may be applied.

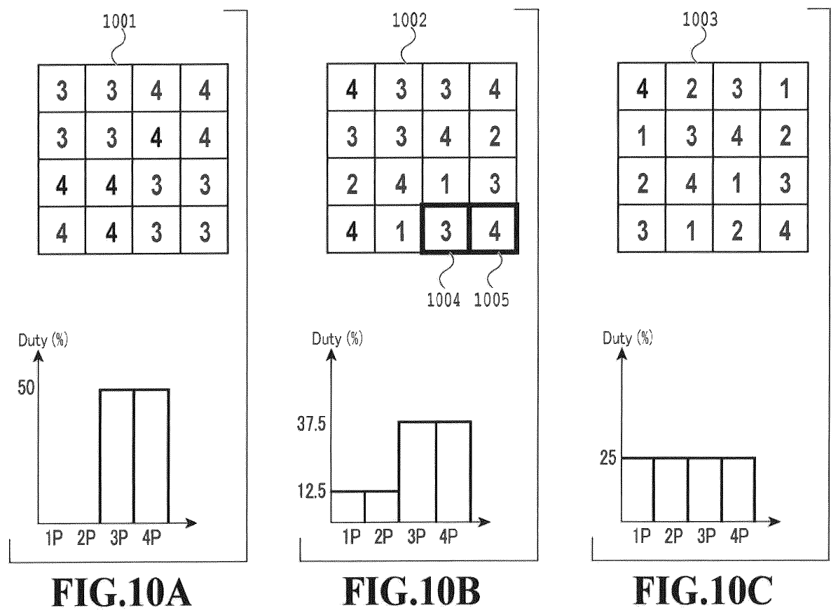

FIGS. 10A to 10C are diagrams illustrating masks selected for each application amount of color material ink in 4×4=16 areas, and the print ratios defined by these masks. A mask 1001 illustrated in FIG. 10A is a mask selected by the mask selection data 801 (FIG. 8) in a case where the application amount of color material ink is relatively small. Since the mask selection data 801 has the mask selection data value of “0” in all 16 areas, the post-applied mask 901 is selected in all areas of the mask 1001. As a result, the mask 1001 is substantially the same as the post-applied mask 901. A mask 1003 illustrated in FIG. 10C is a mask selected by the mask selection data 803 (FIG. 8) in a case where the application amount of color material ink is relatively large. Since the mask selection data 803 has the mask selection data value of “1” in all areas, the normal mask 902 is selected in all areas of the mask 1003. As a result, the mask 1003 is substantially the same as the normal mask 902.

A mask 1002 illustrated in FIG. 10B is a mask selected by the mask selection data 802 (FIG. 8) in a case where the application amount of color material ink is moderate. The mask selection data 802 has eight areas where the mask selection data value is “0” and eight areas where the mask selection data value is “1”. Therefore, in the mask 1002, the post-applied mask 901 is selected in exactly half of all areas and the normal mask 902 is selected in the other half.

The mask 1002 will be described in detail below. As an example, a case where the target area is an area 1004 will be described. The mask selected in the area 1004 is the post-applied mask 901, because the value in the area 804 of the mask selection data 802 is “0”. Therefore, the value “3” in the area 903 of the pre-applied mask 901 corresponding to the area 1004 becomes the value for the area 1004 of the mask 1002. Next, a case where the target area is an area 1005 will be described. The mask selected in the area 1005 next to the area 1004 is the normal mask 902, because the value in the area 805 of the mask selection data 802 is “1”. Therefore, the value “4” in the area 905 of the normal mask 902 corresponding to the area 805 becomes the value for the area 1005 of the mask 1002. By performing the above-described processing on all 16 areas, the mask 1002 illustrated in FIG. 10B is obtained. Furthermore, the number of printable areas in the mask 1002 is two (duty 12.5%) in each of the first and second print scans, and six (duty 37.5%) in each of the third and fourth print scans.

In this way, the post-applied mask 901 is used in a case where the application amount of color material ink is small, thereby efficiently suppressing bleeding and beading between the color material inks and reducing deterioration in gloss and robustness. On the other hand, the normal mask 902 is used in a case where the application amount of color material ink is large, thereby suppressing bleeding and beading caused by the color material inks contacting each other before coming into contact with the reaction liquid. Furthermore, for the moderate application amount of color material ink, a duty between the post-applied mask 901 and the normal mask 902 can be adopted to appropriately suppress bleeding and beading between the color material inks.

As described above, in the present embodiment, in a case of forming an image by four print scans, the application amount of color material ink in the first half and the application amount of color material ink in the second half are appropriately controlled. To be more specific, in a case where the application amount of color material ink is relatively large, the total application amount of color material ink in the first two scans (first and second print scans) is substantially equal to the total application amount of color material ink in the second two scans (third and fourth print scans). On the other hand, in a case where the application amount of color material ink is relatively small, the total application amount of color material ink for printing in the last two scans is larger than the total application amount of color material ink for printing in the first two scans. This print control enables printing with excellent print quality with less bleeding and beading.

Note that the above example is merely an explanation of what kind of mask is used in the mask processing. As described above, whether the color material ink is actually applied or not is determined by AND processing (mask processing) between the color material ink data based on the image data and this mask. For this reason, even if the normal mask 902 is used, for example, the application amount of color material ink used for printing is not the same between the first two scans and the last two scans, if the image data to be printed is biased. For example, in a case where there is print data only in the area printed in the first scan in FIG. 9B, the application amount of color material ink used for printing is not the same between the first two scans and the last two scans. However, such biased image data can be reduced by combining the quantization processing and the masks. Hence, it can be said that the application amount of color material ink is substantially the same without any problem even if there is some bias in the print ratio (preferably within a duty of 10%).

In the present embodiment, 4-pass printing has been described as an example of the multipass printing. However, the multipass printing is not limited to this 4-pass printing, and the effects of the present embodiment can be achieved regardless of the number of passes. In addition, although the multipass printing is described as being complementary by a plurality of print passes, this does not necessarily have to be the case, and dots may be thinned out or increased.

For example, in a case of 5-pass printing, the total application amount of color material ink for printing in the first 2.5 scans and the total application amount of color material ink for printing in the last 2.5 scans can be changed according to the application amount of color material ink. Specifically, the sum of the application amount of color material ink in the first print scan, the application amount of color material ink in the second print scan, and half the application amount of color material ink in the third print scan is the total application amount of the reaction liquid by the first scan in the above-described example. Also, the sum of half the application amount of color material ink in the third print scan, the application amount of color material ink in the fourth print scan, and the application amount of color material ink in the fifth print scan is the total application amount of color material ink in the second scan. Then, as described in the 4-pass example, a mask for controlling the application amount in the first half of the print scans and the application amount in the second half thereof can be appropriately selected according to the application amount based on the image data.

Specifically, in the present embodiment, the printing apparatus 100 performs the following control in printing an image in a unit area by scanning the print head 9 N times (N is an integer equal to or greater than 2) in the main scanning direction. The following cases are assumed: a case where the application amount of color material ink per unit area is a first amount, and a case where the application amount of color material ink per unit area is a second amount larger than the first amount. In this case, in a case where the application amount of color material ink per unit area is the first amount, a first ratio of the application amount of color material ink for printing in the latter N/2 scans to the application amount of color material ink for printing in the first N/2 scans among the N scans to print an image is greater than 1. In a case where the application amount of color material ink per unit area is the second amount, a second ratio of the application amount of color material ink for printing in the latter N/2 scans to the application amount of color material ink for printing in the first N/2 scans among the N scans to print an image is greater than 1, but is smaller than the first ratio. As a mask for the reaction liquid, a mask used to start applying the reaction liquid is adopted in a pass before the pass where the application of the color material ink starts, or in the same pass as the pass where the application of the color material ink starts.

In addition, the print scan in the present embodiment may be a one-way print scan in the +X direction illustrated in FIG. 3, or a two-way print scan in the ±X direction. In the present embodiment, since it is assumed that the reaction liquid is applied to the printing medium before the color material ink, the first print scan is preferably a print scan in the +X direction in the case of two-way print scan.

As described above, according to the present embodiment, the print control according to the application amount of color material ink makes it possible to print an image while suppressing bleeding and beading. Specifically, the mask to be applied to the mask processing of the color material ink is appropriately determined according to the application amount of color material ink based on the image data. By performing the mask processing of the color material ink using the mask thus determined, an image can be printed with suppressed bleeding and beading.

### Second Embodiment

In the present embodiment, based on the contents described in the first embodiment, a mask for the reaction liquid is selected according to the amount of the reaction liquid applied (application amount) as well as the color material ink. Specifically, the same mask as in the example described in the first embodiment is used as the normal mask 902. On the other hand, in a case where the application amount of color material ink is small, that is, in a case where the application amount of the reaction liquid is small, a pre-applied mask is used as the mask for the reaction liquid. In the following description, the same contents as those of the above-described embodiment will be omitted as appropriate.

### <Characteristic Configuration>

The present embodiment is characterized by a method of selecting a mask for the reaction liquid. The method of selecting a mask for the color material ink is the same as in the first embodiment.

FIG. 8 illustrates three representative examples of mask selection data generated in S703 for each application amount of reaction liquid in binary 4×4=16 areas. As mentioned above, the mask selection data differs as appropriate depending on corresponding image data.

FIG. 8 illustrates three examples for explanation purposes. The mask selection data 801 is an example of mask selection data in a case where the application amount of reaction liquid is relatively small, wherein the mask selection data value is “0” in all 16 areas. The mask selection data 803 is an example of mask selection data in a case where the application amount of reaction liquid is relatively large, wherein the mask selection data value is “1” in all 16 areas. The mask selection data 802 is an example of mask selection data in a case where the application amount of reaction liquid is relatively moderate, wherein there are eight areas where the mask selection data value is “0” and eight areas where the mask selection data value is “1”.

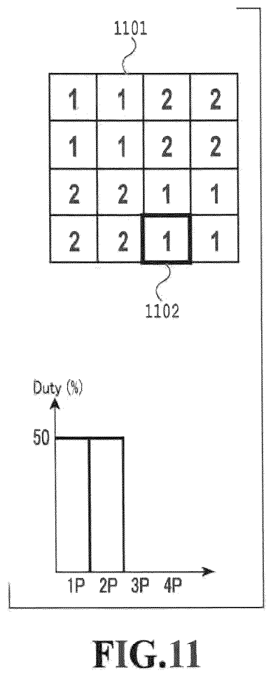

FIGS. 9A and 9B and FIG. 11 are diagrams illustrating masks for the reaction liquid in 4×4=16 areas and the print ratios defined by these masks. FIG. 9B illustrates a normal mask 902 selected in an area where the mask selection data value is “1” . On the other hand, FIG. 11 illustrates a pre-applied mask 1101 selected in an area where the mask selection data value is “0”. In other words, FIG. 11 illustrates a mask selected in an area where the mask selection data value is “0” among the 16 areas. For example, the mask selection data 801 in FIG. 8 has “0” in all areas, and as a result, the same mask as the pre-applied mask 1101, which is a third mask illustrated in FIG. 11, is selected. The normal mask 902, which is a second mask, and the pre-applied mask 1101, which is the third mask, are masks that are prestored in the ROM 302 or the like.

As illustrated in FIG. 9B, in the normal mask 902, the number of printable areas in each of first to fourth print scans is four (duty 25%). On the other hand, as illustrated in FIG. 11, the number of printable areas in the pre-applied mask 1101 is eight (duty 50%) in each of the first and second print scans, and 0 in the third and fourth print scans. In other words, the pre-applied mask 1101 is a mask for completing the application of reaction liquid in the first two scans.

The probability that printing with the reaction liquid is performed in the scan before the color material ink is relatively higher in a case of using the pre-applied mask 1101 than in a case of using the normal mask 902. Therefore, this pre-applied mask 1101 is a mask that efficiently suppresses bleeding between the color material inks. However, the print ratio in the first and second print scans is higher in the case of using the pre-applied mask 901 than in the case of using the normal mask 902. Specifically, as the application amount of reaction liquid becomes larger than a predetermined amount, beading is caused more easily by the reaction liquids contacting each other. Therefore, the pre-applied mask 1101 is used for the areas where the application amount of reaction liquid is relatively small (that is, the mask selection data is 0). On the other hand, the normal mask 902 is used for the areas where the application amount of reaction liquid is relatively large (that is, the mask selection data is 1). Specifically, among the mask selection data defined by the 16 areas, the area of “0” is filled with the value of the position corresponding to that area in the pre-applied mask 1101. Meanwhile, the area of “1” is filled with the value of the position corresponding to that area in the normal mask 902. In this way, a mask having all areas filled with corresponding values is selected. By selecting a mask to be used in the mask processing as described above, bleeding between the color material inks and beading between reaction liquids can be both suppressed. The mask selected in response to the value in each area of the mask selection data may be applied by selecting a pattern stored in the ROM 302 or the like, or a mask appropriately generated from the pre-applied mask 1101 and the normal mask 902 may be applied.

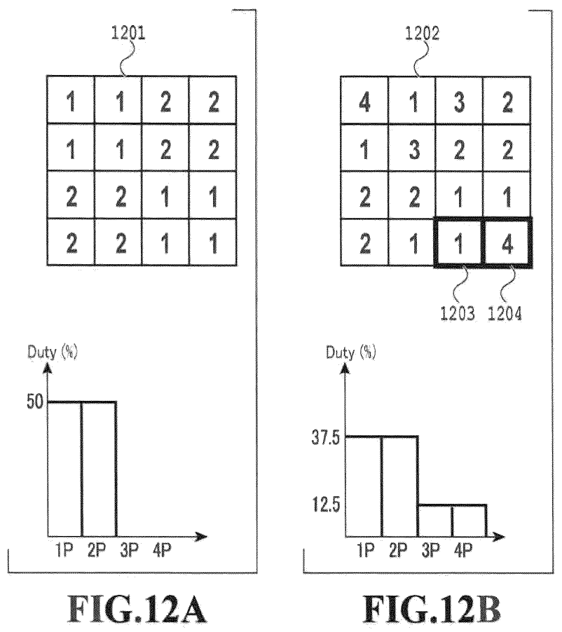

FIGS. 12A and 12B are diagrams illustrating masks selected for each application amount of reaction liquid in 4×4=16 areas, and the print ratios defined by these masks. A mask 1201 illustrated in FIG. 12A is a mask selected by the mask selection data 801 (FIG. 8) in a case where the application amount of reaction liquid is relatively small. Since the mask selection data 801 has the mask selection data value of “0” in all 16 areas, the pre-applied mask 1101 is selected in all areas of the mask 1201. As a result, the mask 1201 is substantially the same as the pre-applied mask 1101.

A mask 1202 illustrated in FIG. 12B is a mask selected by the mask selection data 802 (FIG. 8) in a case where the application amount of reaction liquid is moderate. The mask selection data 802 has eight areas where the mask selection data value is “0” and eight areas where the mask selection data value is “1”. Therefore, in the mask 1202, the pre-applied mask 1101 is selected in exactly half of all areas and the normal mask 902 is selected in the other half.

The mask 1202 will be described in detail below. As an example, a case where the target area is an area 1203 will be described. The mask selected in the area 1203 is the pre-applied mask 1101, because the value in the area 804 of the mask selection data 802 is “0”. Therefore, the value “1” in an area 1102 of the pre-applied mask 1101 corresponding to the area 1203 becomes the value for the area 1203 of the mask 1202. Next, a case where the target area is an area 1204 will be described. The mask selected in the area 1204 next to the area 1203 is the normal mask 902, because the value in the area 805 of the mask selection data 802 is “1”. Therefore, the value “4” in the area 905 of the normal mask 902 corresponding to the area 805 becomes the value for the area 1204 of the mask 1202. By performing the above-described processing on all 16 areas, the mask 1202 illustrated in FIG. 12B is obtained.

Furthermore, the number of printable areas in the mask 1202 is six (duty 37.5%) in each of the first and second print scans, and two (duty 12.5%) in each of the third and fourth print scans.

In this way, the mask used in the mask processing of the reaction liquid in the present embodiment is appropriately selected according to the application amount of reaction liquid based on the image data. For example, in a case where the application amount of reaction liquid is small, the pre-applied mask 1101 is used to efficiently suppress bleeding between the color material inks. In a case where the application amount of reaction liquid is large, on the other hand, the normal mask 902 is used to suppress beading caused by the reaction liquids contacting each other. Furthermore, for the moderate application amount of reaction liquid, a duty between the pre-applied mask 1101 and the normal mask 902 can be adopted to appropriately suppress both bleeding between the color material inks and beading between the reaction liquids.

As described above, in the present embodiment, in a case of printing an image by four print scans, the application amount of reaction liquid in the first half and the application amount of reaction liquid in the last half are appropriately controlled. To be more specific, in a case where the application amount of reaction liquid is relatively large, the total application amount of reaction liquid for printing in the first two scans is substantially equal to the total application amount of reaction liquid for printing in the last two scans. In other words, the total application amount of reaction liquid in the first and second print scans is substantially equal to the total application amount of reaction liquid in the third and fourth print scans. On the other hand, in a case where the application amount of reaction liquid is relatively small, the total application amount of reaction liquid for printing in the first two scans is larger than the total application amount of reaction liquid for printing in the last two scans. This print control enables printing with excellent print quality with less bleeding and beading. In addition to the first embodiment, further effects can be obtained by performing the above print control.

To generalize and abstract the above contents, in the present embodiment, the following control is performed in the printing apparatus 100 configured to print an image in a unit area by scanning the print head 9 N times (N is an integer equal to or greater than 2) in the main scanning direction. The following cases are assumed: a case where the application amount of color material ink per unit area is a first amount, and a case where the application amount of color material ink per unit area is a second amount larger than the first amount.

In this case, in a case where the application amount of color material ink per unit area is the first amount, a first ratio of the application amount of color material ink for printing in the latter N/2 scans to the application amount of color material ink for printing in the first N/2 scans among the N scans to print an image is greater than 1. A first ratio of the application amount of reaction liquid for printing in the latter N/2 scans to the application amount of reaction liquid for printing in the first N/2 scans is smaller than 1.

In a case where the application amount of color material ink per unit area is the second amount (>the first amount), a second ratio of the application amount of color material ink for printing in the latter N/2 scans to the application amount of color material ink for printing in the first N/2 scans among the N scans to print an image is equal to or greater than 1. However, this second ratio is smaller than the first ratio for the application amount of color material ink described above. The second ratio of the application amount of reaction liquid for printing in the latter N/2 scans to the application amount of reaction liquid for printing in the first N/2 scans is equal to or smaller than 1, but is larger than the first ratio for the application amount of reaction liquid described above. A mask is selectively applied so as to achieve the relationship described above.

### Third Embodiment

In the present embodiment, based on the contents described in the first and second embodiments, different masks are used depending on the absorbency of the printing medium. Specifically, the same mask as that described in the first embodiment is used as the normal mask 902. On the other hand, as for the post-applied mask and the pre-applied mask, different masks are used depending on the absorbency of the printing medium.

### <Printing Medium>

In the present embodiment, a low-permeability printing medium as described in the first embodiment and inkjet plain paper will be described as an example of the printing medium. As the low-permeability printing medium, a PET film (GSP-10L) manufactured by Lintec is used. As the inkjet plain paper, standard plain paper 2 (LFPS2) manufactured by Canon is used.

In a case of printing on a printing medium with excellent absorbency, such as inkjet paper or cloth/fabric material, applying the reaction liquid in advance may not effectively suppress bleeding. This is because the reaction components that are applied to the surface of the printing medium and should aggregate with a color material sink into the printing medium over time. Therefore, in the case of the printing medium with excellent absorbency, it is preferable to use a gradual post-applied mask for the color material ink and a gradual pre-applied mask for the reaction liquid, as described below, compared to the low-permeability printing medium.

### <Characteristic Configuration>

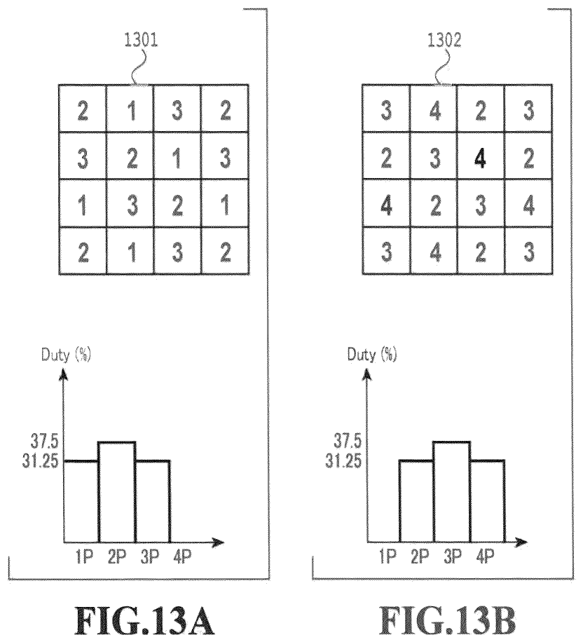

A mask selection method, which is a characteristic configuration of the present embodiment, will be described below with reference to FIGS. 13A and 13B. FIG. 13A illustrates a gradual pre-applied mask 1301 for the reaction liquid and the print ratio defined by this pre-deposition mask. The gradual pre-applied mask 1301 has five printable areas in a first print scan, six printable areas in a second print scan, five printable areas in a third print scan, and no printable areas in a fourth print scan. Therefore, compared to the pre-applied mask 1101 described in the second embodiment, this is a gradual pre-applied mask with a suppressed (reduced) duty in the first and second print scans. In the present embodiment, in a case of using inkjet plain paper as the printing medium, the gradual pre-applied mask 1301 is used instead of the pre-applied mask 1101 (see FIG. 11) described in the second embodiment.

FIG. 13B illustrates a gradual post-applied mask 1302 for color material ink and the print ratio defined by this post-applied mask. The gradual post-applied mask 1302 has no printable areas in the first print scan, five printable areas in the second print scan, six printable areas in the third print scan, and five printable areas in the fourth print scan. Therefore, compared to the post-applied mask 901 described in the first embodiment, this is a gradual post-applied mask with a suppressed (reduced) duty in the third and fourth print scans. In the present embodiment, in a case of using inkjet plain paper as the printing medium, the gradual post-applied mask 1302 is used instead of the post-applied mask 901 described in the first embodiment. The other processing is the same as that described in the first and second embodiments.

Which of the pre-applied mask 1101 and the gradual pre-applied mask 1301 to use is determined by the main control unit 300 based on information obtained about the printing medium to be used. The information about the printing medium to be used may be specified in the application 501 by the user, or may be specified by the user via the display panel 50 of the printing apparatus 100. Alternatively, the printing apparatus 100 may be equipped with a printing medium discrimination sensor, and the main control unit 300 may automatically obtain the information about the printing medium to be used.

Which of the post-applied mask 901 and the gradual post-applied mask 1302 to use is determined by the main control unit 300 based on information obtained about the printing medium to be used. The information about the printing medium to be used may be specified in the application 501 by the user, or may be specified by the user via the display panel 50 of the printing apparatus 100. Alternatively, the printing apparatus 100 may be equipped with a printing medium discrimination sensor, and the main control unit 300 may automatically obtain the information about the printing medium to be used.

As described above, in the present embodiment, in a case of using the printing medium with excellent absorbency, the total application amount of color material ink in the last two scans of the four scans to print an image is set smaller than in a case of using a low-permeability printing medium. Also, the total application amount of reaction liquid in the first two scans is set smaller. By controlling the application amount in this way, an image can be printed with suppressed bleeding and beading, even in a case of using different types of printing media.

To generalize and abstract the above contents, in the present embodiment, a first printing medium or a second printing medium with better absorbency than the first printing medium is used as a printing medium for printing an image. In addition, the following control is performed in the printing apparatus 100 configured to print an image in a unit area on the first printing medium or the second printing medium by scanning the print head 9 N times (N is an integer equal to or greater than 2) in the main scanning direction. Specifically, for the application amount of color material ink for printing in the last N/2 scans among the N scans to print an image, the application amount in a case of using the second printing medium is set smaller than the application amount in a case of using the first printing medium. In addition, for the application amount of reaction liquid for printing in the first N/2 scans among the N scans to print an image, the application amount in a case of using the second printing medium is set smaller than the application amount in a case of using the first printing medium.

### Fourth Embodiment

In the present embodiment, based on the contents described in the first and second embodiments, different masks are used depending on the wettability of the printing medium. Specifically, the same mask as that used in the first embodiment is used as the normal mask 902. On the other hand, as for the post-applied mask and the pre-applied mask, different masks are used depending on the wettability of the printing medium.

### <Printing Medium>

In the present embodiment, a printing medium that does not easily get wet (poor wettability) and a printing medium that easily gets wet (good wettability) will be described as an example of the printing medium. As the printing medium that does not easily get wet, Scotchcal Graphic Film (IJ1220N), a pasted PVC film manufactured by 3M, is used. As the printing medium that easily gets wet, a PET film (GSP-10L) manufactured by Lintec is used.

For the printing medium that does not easily get wet, such as PVC, applying a reaction liquid in advance may not effectively suppress bleeding. This is because the reaction components that are applied to the surface of the printing medium and should aggregate with a color material cause beading on the printing medium over time, thereby reducing the area covering the paper surface and making it difficult to contact the color material ink. Therefore, in the case of the printing medium that does not easily get wet, it is preferable to use a gradual post-applied mask for the color material ink and a gradual pre-applied mask for the reaction liquid, as described below, compared to the printing medium that easily gets wet.

### <Characteristic Configuration>

A mask selection method, which is a characteristic configuration of the present embodiment, will be described below with reference to FIGS. 13A and 13B. In the present embodiment, as in the third embodiment, a gradual pre-applied mask 1301 and a gradual post-applied mask 1302 are prepared. In a case of using a pasted PVC film as the printing medium, the gradual pre-applied mask 1301 is used instead of the pre applied mask 1101 described in the second embodiment, and the gradual post-applied mask 1302 is used instead of the post-applied mask 901 described in the first embodiment.

Which of the pre-applied mask 1101 and the gradual pre-applied mask 1301 to use is determined by the main control unit 300 based on information obtained about the printing medium to be used. The information about the printing medium to be used may be specified in the application 501 by the user, or may be specified by the user via the display panel 50 of the printing apparatus 100. Alternatively, the printing apparatus 100 may be equipped with a printing medium discrimination sensor, and the main control unit 300 may automatically obtain the information about the printing medium to be used.

Which of the post-applied mask 901 and the gradual post-applied mask 1302 to use is determined by the main control unit 300 based on information obtained about the printing medium to be used. The information about the printing medium to be used may be specified in the application 501 by the user, or may be specified by the user via the display panel 50 of the printing apparatus 100. Alternatively, the printing apparatus 100 may be equipped with a printing medium discrimination sensor, and the main control unit 300 may automatically obtain the information about the printing medium to be used.

As described above, in the present embodiment, in a case of using the printing medium that does not easily get wet, the total application amount of color material ink for printing in the last two scans of the four scans to print an image is set smaller than that of the printing medium that easily gets wet. Also, the total application amount of reaction liquid for printing in the first two scans is set smaller. By controlling the application amount in this way, an image can be printed with suppressed bleeding and beading, even in a case of using different types of printing media.

To generalize and abstract the above contents, in the present embodiment, a first printing medium or a third printing medium that does not easily get wet (poor wettability) compared to the first printing medium is used as a printing medium for printing an image. In addition, the following control is performed in the printing apparatus 100 configured to print an image in a unit area on the first printing medium or the third printing medium by scanning the print head 9 N times (N is an integer equal to or greater than 2) in the main scanning direction. Specifically, for the application amount of color material ink for printing in the last N/2 scans among the N scans to print an image, the application amount in a case of using the third printing medium is set smaller than the application amount in a case of using the first printing medium. In addition, for the application amount of reaction liquid for printing in the first N/2 scans among the N scans to print an image, the application amount in a case of using the third printing medium is set smaller than the application amount in a case of using the first printing medium.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The present disclosure makes it possible to reduce deterioration in gloss and robustness while suppressing bleeding and beading of color material ink.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-162435, filed Sep. 19, 2024, which is hereby incorporated by reference herein in its entirety.

What is claimed is:

1. A printing apparatus comprising:
a printing unit having a first ejection port array in which ejection ports for ejecting a color material ink are arrayed along a sub-scanning direction, and a second ejection port array in which ejection ports for ejecting a reaction liquid are arrayed along the sub-scanning direction; and
a control unit configured to execute multipass printing to print an image in a predetermined region on a printing medium by scanning the printing unit N times (N is an integer equal to or greater than 2) in a main scanning direction intersecting the sub scanning direction, and to perform control so that, in a case where an application amount of the color material ink per unit area corresponding to the predetermined region on the printing medium is a first amount, a first ratio of an application amount of the color material ink for printing in last N/2 scans to an application amount of the color material ink for printing in first N/2 scans among the N scans for printing an image is greater than 1, and, in a case where the application amount of the color material ink per unit area corresponding to the predetermined region on the printing medium is a second amount larger than the first amount, a second ratio of the application amount of the color material ink for printing in the last N/2 scans to the application amount of the color material ink for printing in the first N/2 scans among the N scans for printing an image is equal to or greater than 1 and smaller than the first ratio.

2. The printing apparatus according to claim 1, wherein
application of the reaction liquid is started in a pass prior to a pass in which application of the color material ink is started, or in the same pass as the pass in which application of the color material ink is started.

3. The printing apparatus according to claim 2, wherein
the first ejection port array for ejecting the color material ink is provided on an upstream side of the second ejection port array for ejecting the reaction liquid in the main scanning direction.

4. The printing apparatus according to claim 1, wherein
in a case where the application amount of the color material ink per unit area corresponding to the predetermined region on the printing medium is a third amount, a third ratio of an application amount of the reaction liquid for printing in last N/2 scans to an application amount of the reaction liquid for printing in first N/2 scans among the N scans to print an image is smaller than 1, and
in a case where the application amount of the color material ink per unit area corresponding to the predetermined region on the printing medium is a fourth amount larger than the third amount, a fourth ratio of the application amount of the reaction liquid for printing in the last N/2 scans to the application amount of the reaction liquid for printing in the first N/2 scans among the N scans to print an image is equal to or smaller than 1 and is larger than the third ratio.

5. The printing apparatus according to claim 4, wherein
a first printing medium and a second printing medium having better absorbency than the first printing medium can be used as the printing medium, and
the application amount of the color material ink for printing in the last N/2 scans among the N scans to print an image is set smaller in a case of using the second printing medium than in a case of using the first printing medium.

6. The printing apparatus according to claim 5, wherein
the application amount of the reaction liquid for printing in the first N/2 scans among the N scans to print an image is set smaller in a case of using the second printing medium than in a case of using the first printing medium.

7. The printing apparatus according to claim 4, wherein
a third printing medium and a fourth printing medium having poorer wettability than the third printing medium can be used as the printing medium, and
the application amount of the color material ink for printing in the last N/2 scans among the N scans to print an image is set smaller in a case of using the fourth printing medium than in a case of using the third printing medium.

8. The printing apparatus according to claim 7, wherein
the application amount of the reaction liquid for printing in the first N/2 scans among the N scans to print an image is set smaller in a case of using the fourth printing medium than in a case of using the third printing medium.

9. The printing apparatus according to claim 1, wherein
the control unit performs the control by mask processing using a mask.

10. The printing apparatus according to claim 9, wherein
the control unit generates mask selection data for selecting a mask to be used in the mask processing based on target image data to be printed in the predetermined region, and determines the mask to be used in the mask processing in the predetermined region, based on the mask selection data.

11. The printing apparatus according to claim 10, further comprising:
a conveyance unit configured to convey the printing medium.

12. A control method for a printing apparatus including
a printing unit having a first ejection port array in which ejection ports for ejecting a color material ink are arrayed along a sub-scanning direction, and a second ejection port array in which ejection ports for ejecting a reaction liquid are arrayed along the sub-scanning direction, and
a control unit configured to execute multipass printing to print an image in a predetermined region on a printing medium by scanning the printing unit N times (N is an integer equal to or greater than 2) in a main scanning direction intersecting the sub scanning direction,
the control method comprising:
causing the control unit to perform control so that, in a case where an application amount of the color material ink per unit area corresponding to the predetermined region on the printing medium is a first amount, a first ratio of an application amount of the color material ink for printing in last N/2 scans to an application amount of the color material ink for printing in first N/2 scans among the N scans for printing an image is greater than 1, and, in a case where the application amount of the color material ink per unit area corresponding to the predetermined region on the printing medium is a second amount larger than the first amount, a second ratio of the application amount of the color material ink for printing in the last N/2 scans to the application amount of the color material ink for printing in the first N/2 scans among the N scans for printing an image is equal to or greater than 1 and smaller than the first ratio.

13. A non-transitory computer readable storage medium storing a program for causing a computer to execute a control method for a printing apparatus including a printing unit having a first ejection port array in which ejection ports for ejecting a color material ink are arrayed along a sub-scanning direction, and a second ejection port array in which ejection ports for ejecting a reaction liquid are arrayed along the sub-scanning direction, and a control unit configured to execute multipass printing to print an image in a predetermined region on a printing medium by scanning the printing unit N times (N is an integer equal to or greater than 2) in a main scanning direction intersecting the sub scanning direction,
the control method comprising:
causing the control unit to perform control so that, in a case where an application amount of the color material ink per unit area corresponding to the predetermined region on the printing medium is a first amount, a first ratio of an application amount of the color material ink for printing in last N/2 scans to an application amount of the color material ink for printing in first N/2 scans among the N scans for printing an image is greater than 1, and, in a case where the application amount of the color material ink per unit area corresponding to the predetermined region on the printing medium is a second amount larger than the first amount, a second ratio of the application amount of the color material ink for printing in the last N/2 scans to the application amount of the color material ink for printing in the first N/2 scans among the N scans for printing an image is equal to or greater than 1 and smaller than the first ratio.
